(19) United States
(12) Patent Application Publication
(10) Pub. No.: US 2017/0227142 A1
(43) Pub. Date: Aug. 10, 2017

(54) PIPE HANGER

(71) Applicant: Junjie HUANG, Fuzhou (CN)

(72) Inventor: Junjie HUANG, Fuzhou (CN)

(21) Appl. No.: 15/435,989

(22) Filed: Feb. 17, 2017

Related U.S. Application Data
(60) Provisional application No. 62/296,795, filed on Feb. 18, 2016.

(51) Int. Cl. F16L 3/10; F16L 3/11

(52) U.S. Cl. CPC F16L 3/1075; F16L 3/11

(57) ABSTRACT

A method and apparatus for hanging a pipe from an overhead structure is presented herein. The pipe hanger disclosed herein comprises two halves swingable with respect to each other about a hinge and secured at the bottom by closing the two halves together. The lower ends of the two halves might comprise two flanges configured to mate with each other securely so as to firmly fix the pipe within the body of the pipe hanger. The upper end of the larger half preferably having a hole, or other method for hanging the pipe hanger from an overhead structure, such as the ceiling of a building, for example. Also disclosed is one or more lower flanges with a threaded aperture to accept a threaded bolt by without the need for a nut. A deflectable tongue attachment firmly secured to a flange is also disclosed which allows an operator to push a bolt or screw through the flange and two deflectable tongues on the attachment. The deflectable tongues deflect outward from the pipe hanger preventing the bolt or screw from coming out.

### CROSS REFERENCE TO RELATED APPLICATIONS

This application claims priority to U.S. provisional patent application Ser. No. 62/296,795, filed on Feb. 18, 2016.

### BACKGROUND OF THE INVENTION

1. Technical Field

The invention disclosed herein relates to building materials. In particular, this device relates to hanging pipe or other conduit from on overhead structure.

2. Related Art

This patent claims priority to U.S. Pat. Nos. 411,518, 851,505, 1,579,418, 1,883,935, and 2,375,513. All of these patents are incorporated in their entirety, herein.

When hanging pipe from the ceiling of a structure such as a building, problems present that the worker is usually on a ladder with limited use of his hands. Thus, a simplified pipe hanger is desired. It is also desired that the structure of the pipe hanger, itself, not be stretched, pried, or deformed, thereby weakening the hanger. In all the cited patents other than U.S. Pat. No. 851,505, the hanger must be pried open, while some the hangers must then also be pried shut and clamped shut with a bolt, requiring the worker to retrieve the nut from the carriage bolt. This takes a lot of screwing and unscrewing, prying open and prying shut. U.S. Pat. No. 2,375,513, FIG. 1, is a good example of this.

Meanwhile U.S. Pat. Nos. 851,505 and 1,575,418 are examples of pipe hangers that must be pried and stretched in order to clamp shut.

Building owners, building businesses, and building laborers are always looking for faster, more cost efficient ways to build. Thus, improvements in the pipe hanger space will always be needed.

### SUMMARY

Disclosed in an apparatus and method for hanging pipe from overhead.

Preferably, the pipe hanger hangs pipe from an overhead structure such as a building, bridge, or other structures from with pipes or conduits hang.

Instead of prying opening two halves of the body of a pipe hanger, the operator need swing open one half to receive a conduit or pipe. Then, in one non-limiting example, an operator can use the disclosed invention to hang pipe without the need for a tool: the operator then push or thrust the bolt that already is retained on the swingable or side, through the deflectable tongue or threaded aperture until shoulder of bolt head touches the body of the hanger. The operator thus finished hanging the pipe without the need for a tool.

In one embodiment, a threaded aperture is punched and/or stamped at the bottom of the pipe hanger to function as a nut. This may make the pipe hanger cheaper to produce and eliminates the need for a nut.

Meanwhile, another embodiment comprises a deflectable tongue configured to be firmly attached to the bottom of the pipe hanger, such as to allow a bolt to be pushed or screwed through it, for example, tool-lessly or not, in one direction, so that the bolt cannot be pulled back as the tongue-like members extend and lock into the thread(s) of the bolt. One advantage of this method and apparatus is that it may save labor time.

According to one aspect of the disclosure, we have a pipe hanger comprising a body,

wherein the body further comprises a larger half and a smaller half, and wherein the smaller half is attached to the larger half with a hinge. Further comprising a center hole at the upper end of the larger half for attaching the body to a rigid structure, and a clamp at the lower end of the body configured to close both the larger and smaller halves of the body together.

In another embodiment, the clamp at the lower end comprises two flange members, each with holes configured to accept a bolt. It is also disclosed that at least one flange member comprises a deflectable tongue attachment and the deflectable tongue attachment is configured to lock the bolt in place with two deflectable tongue members.

In yet another embodiment, at least one of the holes in the flange members is threaded to accept a threaded bolt without the need for a nut.

Disclosed herein is a deflectable tongue attachment comprising a base configured to firmly attach the deflectable tongue attachment over a hole configured to accept a bolt, and one or more deflectable tongues configured to extent outward from the base so that the bolt remains in place.

By way of non-limiting example, the pipe hanger body may be round, square or rectangular, or any other shape known to those skilled in this art.

Disclosed herein is a method of hanging a pipe that for example may include placing a pipe or conduit in the body of a pipe hanger comprising a larger half and a smaller half hinged together and swingable with respect to each other, securing the pipe in the body of the pipe hanger by closing together the two halves of the body of the pipe hanger, attaching two halves together with a bolt and clamping mechanism, and hanging the pipe hanger by attaching the top of the pipe hanger to an overhead structure.

In one embodiment of this method, securing the pipe in the body of the pipe member comprises closing together the two halves of the body of the pipe hanger by providing a flanged member at the lower end of both the larger half and the smaller half of the body so that both flanged members securely mate together, for example.

Also by way of non-limiting example the method of hanging a pipe might further comprise mating the flange members together with a deflectable tongue attachment firmly attached to one or more of the flange members. Another example might include boring a threaded aperture in one or more of the flange members.

Yet even more embodiments will be apparent to one skilled in the art of the invention and this summary of the invention is meant to merely provide the reader with examples of the invention claimed in the claims and described in more detail in the Figures, below.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIGS. 1A and 1B are alternate views of one closed pipe hanger according to the present invention.

FIGS. 2A and 2B are illustrations of an open pipe hanger according to the present invention having a threaded aperture.

FIG. 3 is an illustration of a deflectable tongue attachment.

### DETAILED DESCRIPTION OF THE PREFERRED EMBODIMENTS

While the invention has been shown and described with reference to a particular embodiment thereof, it will be understood to those skilled in the art, that various changes in form and details may be made therein without departing from the spirit and scope of the invention.

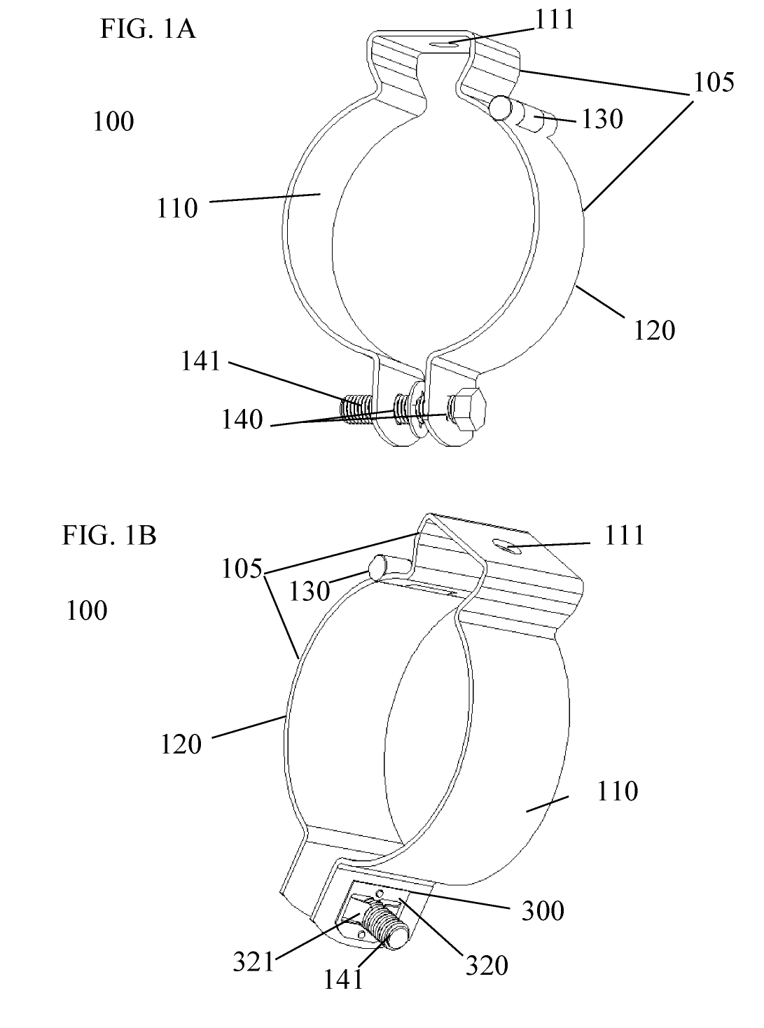

Turning now to FIGS. 1A and 1B, Pipe Hanger 100 comprises a rigid body 105. The body 105 has a larger half 110 and a smaller half 120. Larger half 110 has a hole 111 at its top for attaching pipe hanger 100 to an overhead structure. In a preferred embodiment, the overhead structure is simply the ceiling of a building, an overhead beam, or any other structure known in the art for hanging pipe from.

Larger half 110 is connected to smaller half 120 by a hinge mechanism 130. Hinge 130 is placed anywhere along the arc of the entire body 105 of the pipe hanger 100. In one embodiment, hinge 130 is placed towards the top of the body 105 of pipe hanger 100. Hinge 130 is configured to make the smaller half 120 swingable upwards from the bottom of larger half 110 so that a pipe can be received within pipe hanger 100.

FIGS. 1A and 1B depict a pipe hanger 100 body 105 shaped to receive a round conduit but one skilled in the art would recognize that the body 105 could have any shape, including but not limited to rectangular and square. Body 105 of FIG. 1A also comprises a lower section configured to facilitate the closure of pipe hanger 100; herein all possible shape, size, and manner of these facilitators shall be called lower flanges 140, with flanges 140 comprising two halves, one at the bottom of larger half 110 and the other half at the bottom of smaller half 120, so that the larger half 110 of pipe hanger 100 and smaller half 120 of pipe hanger 100 attach or clamp together to secure the conduit or pipe. In this illustration, lower flanges 140 is configured to accept bolt 141.

Finally, FIG. 1B depicts lower flanges 140 closed by bolt 141 using deflector attachment 300. Deflector 300 has a base 320 with two deflectable members 321 configured to accept and secure bolt 140. Deflector attachment 300 will be discussed in more detail, below.

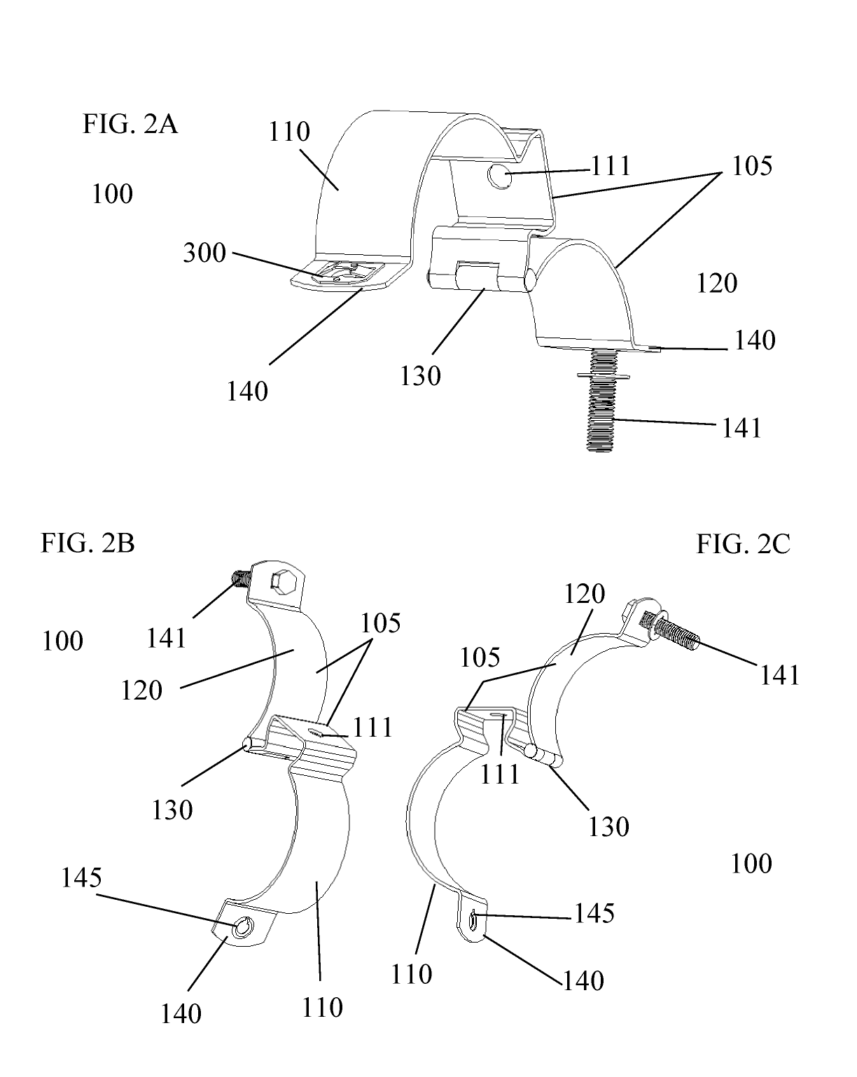

FIG. 2A is an open depiction of the same pipe hanger, 100. FIG. 2A depicts in more detail the hinge mechanism 130, which again, can be placed anywhere along the arc of body 105. The same numbering from FIGS. 1A and 1B apply to FIGS. 2A, 2B and 2C.

FIGS. 2B and 2C, however, depict a pipe hanger 100 different from all previous figures shown. In FIGS. 2B and 2C, lower flanges 140 each contain an aperture 145 for receiving bolt 141. In FIGS. 2B and 2C we see that aperture 145 on the large half 110 is threaded to receive a threaded bolt or screw. However, it would be apparent to one skilled in the art that any or all apertures 145 can be threaded, including the aperture on the smaller half 120.

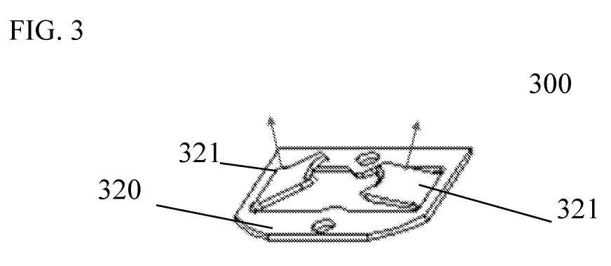

FIG. 3, the final figure, depicts a deflectable tongue 300. Deflectable tongue 300 comprises a base 320 with two deflectable members 321a, 321b that extent outward from the lower flanges 140 when bolt 141 is inserted through the base 320. Base 320 is also configured to firmly attach to one of the lower flanges 140 so as to close body 105 and secure the pipe inside the pipe hanger 100, of which FIG. 1B is a good example.

All Figures except FIG. 3. depict pipe hangers 100 that can be closed tool-less-ly, with tool-less operation being another preferred embodiment of the invention.

While various embodiments of the invention have been described, it will be apparent to those of ordinary skill in the art that many more embodiments and implementations are possible within the scope of the invention. The various embodiments described herein include a variety of materials, hinges, attachment members, and methods of securing, swinging, and closing. The described example configurations of elements and methods are examples that may be embodied through equivalent configurations having additional or fewer of the described elements, systems, devices, and methods, alternative elements, materials, systems, devices, and methods within the scope of invention. Accordingly, the invention is not to be restricted except in light of the attached claims and their equivalents.

We claim:

1. A pipe hanger comprising:
A body,
wherein the body further comprises a larger half and a smaller half, and
wherein the smaller half is attached to the larger half with a hinge,
A center hole at the upper end of the larger half for attaching the body to a rigid structure, and
A clamp at the lower end of the body configured to close both the larger and smaller halves of the body together.

2. The pipe hanger of claim 1, wherein the clamp at the lower end comprises two flange members, each with holes configured to accept a bolt.

3. The pipe hanger of claim 2, wherein at least one flange member comprises a deflectable tongue attachment and the deflectable tongue attachment is configured to lock the bolt in place with two deflectable tongue members.

4. The pipe hanger of claim 1, wherein at least one of the holes in the flange members is threaded to accept a threaded bolt without the need for a nut.

5. A deflectable tongue attachment comprising:
A base configured to firmly attach the deflectable tongue attachment over a hole configured to accept a bolt, and
One or more deflectable tongues configured to extent outward from the base so that the bolt remains in place.

6. The pipe hanger of claim 1 wherein the body is round, square or rectangular.

7. A method of hanging a pipe comprising:
placing a pipe or conduit in the body of a pipe hanger comprising a larger half and a smaller half hinged together and swingable with respect to each other,
securing the pipe in the body of the pipe hanger by:
closing together the two halves of the body of the pipe hanger,
attaching two halves together with a bolt and clamping mechanism, and
hanging the pipe hanger by attaching the top of the pipe hanger to an overhead structure.

8. The method of claim 7, wherein securing the pipe in the body of the pipe member comprises:
closing together the two halves of the body of the pipe hanger by providing a flanged member at the lower end of both the larger half and the smaller half of the body so that both flanged members securely mate together.

9. The method of claim 8, further comprising mating the flange members together with a deflectable tongue attachment firmly attached to one or more of the flange members.

10. The method of claim 8, further comprising boring a threaded aperture in one or more of the flange members.
